(19) United States
(12) Patent Application Publication
(10) Pub. No.: US 2025/0372312 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/302,474

(22) Filed: Aug. 18, 2025

Related U.S. Application Data
(63) Continuation of application No. PCT/JP2024/007531, filed on Feb. 29, 2024.

(30) Foreign Application Priority Data
Apr. 19, 2023 (JP) 2023-068358

(51) Int. Cl. H01G 4/30; H01G 4/008; H01G 4/12; H01G 4/248

(52) U.S. Cl. CPC H01G 4/30; H01G 4/008; H01G 4/1218; H01G 4/248

(57) ABSTRACT

A multilayer ceramic capacitor includes end surface internal electrodes each exposed at end surfaces of a laminate, and side surface internal electrodes each exposed at side surfaces of the laminate. An end surface internal electrode closest to a first-main-surface side has a greater cross-sectional area in a first reference cross-section than an end surface internal electrode with a greatest cross-sectional area in the first reference cross-section among the end surface internal electrodes in either of a second-main-surface-side region and an intermediate region. A side surface internal electrode closest to the first-main-surface side has a greater cross-sectional area in a second reference cross-section than a side surface internal electrode that has a greatest cross-sectional area in the second reference cross-section among the side surface internal electrodes in either of the second-main-surface-side region and the intermediate region.

### CROSS REFERENCE TO RELATED APPLICATIONS

This application claims the benefit of priority to Japanese Patent Application No. 2023-068358 filed on Apr. 19, 2023 and is a Continuation Application of PCT Application No. PCT/JP2024/007531 filed on Feb. 29, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors have been known in which a plurality of dielectric layers made of ceramic material and a plurality of internal electrode layers are laminated. In such multilayer ceramic capacitors, in order to achieve a further increase in capacitance, attempts have been made to reduce the thickness of the dielectric layers, reduce the thickness of the internal electrode layers, and increase the number of laminated layers (see, for example, Japanese Unexamined Patent Application, Publication No. 2010-059467).

However, in the conventional multilayer ceramic capacitors, when signal transmission is performed in a high frequency region, ESL (equivalent series inductance) may become excessive. Therefore, it is necessary to achieve low ESL in the multilayer ceramic capacitors.

### SUMMARY OF THE INVENTION

Example embodiments of the present invention provide multilayer ceramic capacitors that are each able to reduce ESL while achieving large capacitance.

A multilayer ceramic capacitor according to an example embodiment of the present invention includes a multilayer body including a plurality of dielectric layers that are laminated and a plurality of internal electrodes each on a corresponding one of the plurality of dielectric layers, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, a pair of end surface external electrodes on the first end surface and the second end surface, respectively, and a pair of lateral surface external electrodes on the first lateral surface and the second lateral surface, respectively, in which the plurality of internal electrodes include end surface internal electrodes exposed at each of the first end surface and the second end surface and lateral surface internal electrodes exposed at each of the first lateral surface and the second lateral surface, in which, when a cross section parallel or substantially parallel to the length direction and the lamination direction and passing through a middle portion of the end surface internal electrodes in the width direction is defined as a first reference cross section, a cross section parallel or substantially parallel to the width direction and the lamination direction and passing through a middle portion of the lateral surface internal electrodes in the length direction is defined as a second reference cross section, and the multilayer body is equally or substantially equally divided into three regions in the lamination direction to define a first main surface-side region located adjacent to the first main surface, a second main surface-side region located adjacent to the second main surface, and an intermediate region located between the first main surface-side region and the second main surface-side region, an end surface internal electrode closest to the first main surface among the end surface internal electrodes has a larger cross-sectional area in the first reference cross section than a cross-sectional area in the first reference cross section of an end surface internal electrode having a largest cross-sectional area among the end surface internal electrodes provided in either the second main surface-side region or the intermediate region, and a lateral surface internal electrode closest to the first main surface among the lateral surface internal electrodes has a larger cross-sectional area in the second reference cross section than a cross-sectional area in the second reference cross section of a lateral surface internal electrode having a largest cross-sectional area among the lateral surface internal electrodes provided in either the second main surface-side region or the intermediate region.

According to example embodiments of the present invention, multilayer ceramic capacitors that are each able to reduce ESL while achieving large capacitance are provided. The above and other elements, features, steps,

characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view of the multilayer ceramic capacitor 1 according to the first example embodiment taken along the II-II direction in FIG. 1.

FIG. 3 is a cross-sectional view of the multilayer ceramic capacitor 1 according to the first example embodiment taken along the III-III direction in FIG. 1.

FIG. 4 is a flowchart showing an example of a manufacturing method of the multilayer ceramic capacitor 1 according to the first example embodiment of the present invention.

FIG. 5 is a schematic perspective view of a multilayer ceramic capacitor 100 according to a second example embodiment of the present invention.

FIG. 6 is a cross-sectional view of the multilayer ceramic capacitor 100 according to the second example embodiment taken along the VI-VI direction in FIG. 5.

### DETAILED DESCRIPTION OF THE EXAMPLE EMBODIMENTS

Example embodiments of the present invention will be described in detail below with reference to the drawings.

### First Example Embodiment

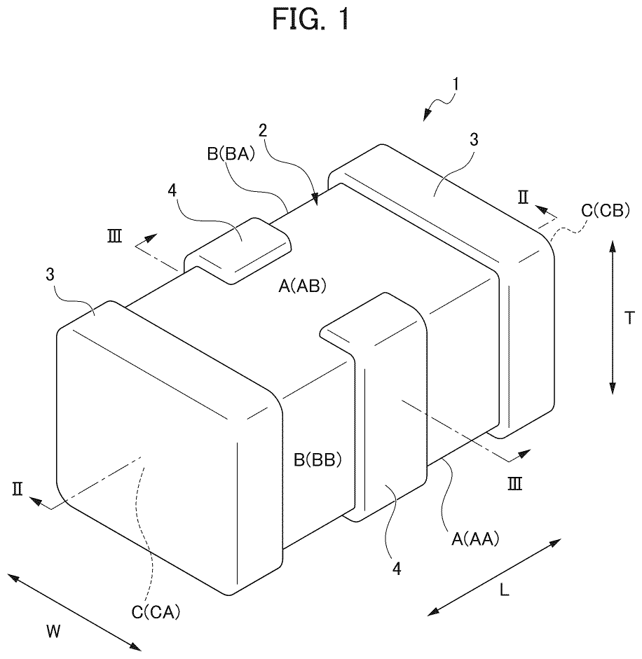

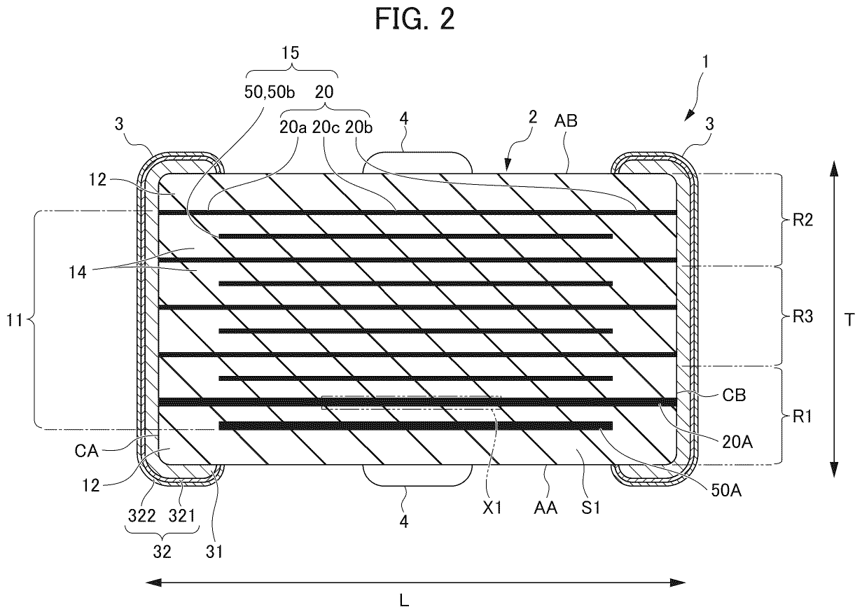

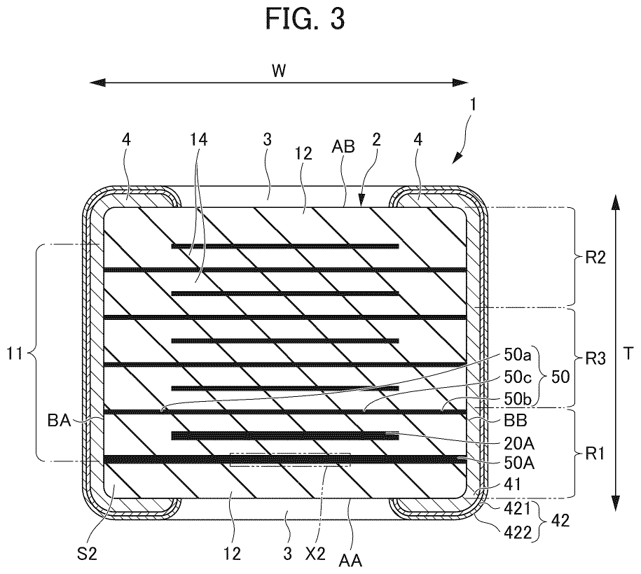

Hereinafter, a multilayer ceramic capacitor 1 according to a first example embodiment of the present invention will be described. FIG. 1 is a schematic perspective view of the multilayer ceramic capacitor 1. FIG. 2 is a cross-sectional view of the multilayer ceramic capacitor 1 taken along the II-II direction in FIG. 1. FIG. 3 is a cross-sectional view of the multilayer ceramic capacitor 1 taken along the III-III direction in FIG. 1.

### Multilayer Ceramic Capacitor 1

As shown in FIG. 1, the multilayer ceramic capacitor 1 is a three-terminal multilayer ceramic capacitor 1 including a pair of end surface external electrodes 3 provided on both end surfaces C in the length direction L of a multilayer body 2, and a pair of lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal or substantially orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C. One of the main surfaces A is defined as a first main surface AA, and the other is defined as a second main surface AB. One of the lateral surfaces B is defined as a first lateral surface BA, and the other is defined as a second lateral surface BB. One of the end surfaces C is defined as a first end surface CA, and the other is defined as a second end surface CB.

The cross section of FIG. 2 is a cross section parallel or substantially parallel to the length direction L and the lamination direction T and passing through the middle portion in the width direction W of end surface internal electrodes 20, and may be referred to as a “first reference cross section S1”. The cross section of FIG. 3 is a cross section parallel or substantially parallel to the width direction W and the lamination direction T and passing through the middle portion in the length direction L of lateral surface internal electrodes 50, and may be referred to as a “second reference cross section S2”.

### Multilayer Body 2

The multilayer body 2 includes an inner layer portion 11 and outer layer portions 12 provided on both sides of the inner layer portion 11 in the lamination direction T. The multilayer body 2 preferably has rounded corner portions and ridge portions. The corner portions are portions where three surfaces of the multilayer body intersect, and the ridge portions are portions where two surfaces of the multilayer body intersect.

### Inner Layer Portion 11

As shown in FIGS. 2 and 3, the inner layer portion 11 includes a plurality of dielectric layers 14 and internal electrodes 15 laminated along the lamination direction T.

### Dielectric Layer 14

The dielectric layers 14 are each made of a ceramic material. As the ceramic material, for example, a dielectric ceramic with BaTiOs as a main component is used. Also, as the ceramic material, for example, one in which at least one of subcomponents such as Mn compound, Fe compound, Cr compound, Co compound, Ni compound, etc., is added to these main components may be used.

### Internal Electrode 15

The internal electrodes 15 are each preferably made of a metal material such as, for example, Ni, Cu, Ag, Pd, Ag—Pd alloy, Au, or the like.

The internal electrodes 15 include a plurality of end surface internal electrodes 20 and a plurality of lateral surface internal electrodes 50 that are alternately provided with each other. The end surface internal electrodes 20 and the lateral surface internal electrodes 50 may be collectively referred to as “internal electrodes 15” when there is no particular need to distinguish between them.

### End Surface Internal Electrode 20

The end surface internal electrodes 20 each extend between both end surfaces C in the length direction L of the multilayer body 2 and are each exposed at each of the end surfaces C. The end surface internal electrodes 20 are each spaced apart from both lateral surfaces B in the width direction W by a certain distance. Each of the end surface internal electrodes 20 includes a first counter portion 20c opposed to the lateral surface internal electrodes 50 adjacent in the lamination direction T, and first extension portions 20a, 20b extending from the first counter portion 20c and exposed at the two end surfaces C, respectively. Specifically, the first counter portion 20c is located at the middle portion between both end surfaces C.

### Lateral Surface Internal Electrode 50

The lateral surface internal electrodes 50 each extend between both lateral surfaces B in the width direction W of the multilayer body 2 and are each exposed at each of the lateral surfaces B. The lateral surface internal electrodes 50 are each slightly smaller than the multilayer body 2 and are each spaced apart from both end surfaces C in the length direction L by a certain distance. Each of the lateral surface internal electrodes 50 includes a second counter portion 50c that is opposed to the end surface internal electrodes 20 adjacent in the lamination direction T, and second extension portions 50a, 50b that extend from the second counter portion 50c and are exposed at the two lateral surfaces B, respectively. Specifically, the second counter portion 50c is located at the middle portion between both lateral surfaces B.

### Outer Layer Portion 12

The outer layer portions 12 are each a dielectric layer having a constant thickness provided adjacent to the main surface A of the inner layer portion 11. The outer layer portions 12 are each made of the same material as the dielectric layer 14 of the inner layer portion 11.

### End Surface External Electrode 3

The pair of end surface external electrodes 3 are provided on both end surfaces C of the multilayer body 2, respectively. The first extension portions 22 are connected to each of the end surface external electrodes 3, respectively. Each of the end surface external electrodes 3 covers not only a corresponding one of the end surfaces C, but also a portion of the main surface A and a portion of the lateral surface B adjacent to the end surface C. Each of the end surface external electrodes 3 includes a base electrode layer 31 and a plated layer 32 provided on the base electrode layer 31. The plated layer 32 includes, for example, a Ni (nickel) plated layer 321 provided on the base electrode layer 31 and a Sn (tin) plated layer 322 provided on the Ni plated layer 321.

### Lateral Surface External Electrode 4

The pair of lateral surface external electrodes 4 are provided on both lateral surfaces B of the multilayer body 2, respectively. The second extension portions 52 are connected to each of the lateral surface external electrodes 4, respectively. Each of the lateral surface external electrodes 4 covers not only a corresponding one of the lateral surfaces B, but also a portion of the main surface A adjacent to the lateral surface B. Each of the lateral surface external electrodes 4 includes a base electrode layer 41 and a plated layer 42 provided on the base electrode layer 41. The plated layer 42 includes, for example, a Ni (nickel) plated layer 421 provided on the base electrode layer 41 and a Sn (tin) plated layer 422 provided on the Ni plated layer 421. The end surface external electrode 3 and the lateral surface external electrode 4 may be collectively referred to as “external electrodes 3, 4”.

### First Main Surface-Side Region R1, Second Main Surface-Side Region R2, and Intermediate Region R3

When the multilayer body is divided into three equal or substantially equal regions in the lamination direction T, among the three regions, the region located adjacent to the first main surface is defined as the first main surface side region R1, the region located adjacent to the second main surface is defined as the second main surface side region R2, and the region located between the first main surface-side region R1 and the second main surface-side region R2 is defined as the intermediate region R3. In the multilayer ceramic capacitors, high-frequency current tends to flow near the mounting substrate, and low-frequency current tends to flow on the side spaced away from the mounting substrate side. Therefore, for example, when the multilayer ceramic capacitor is mounted with the first main surface facing the mounting substrate, the region adjacent to the first main surface of the multilayer body is a region where high-frequency current tends to flow (may be referred to as a “high-frequency region”), and the region adjacent to the second main surface is a region where low-frequency current tends to flow (may be referred to as a “low-frequency region”).

### Cross-Sectional Area of Internal Electrode 15

Here, when an end surface internal electrode closest to the first main surface AA among the end surface internal electrodes is defined as an outermost end surface internal electrode 20A, the outermost end surface internal electrode 20A has a larger cross-sectional area than the end surface internal electrode 20 having the largest cross-sectional area (described in detail later) among the end surface internal electrodes 20 provided in either the second main surface side region R2 or the intermediate region R3.

When a lateral surface internal electrode 50 closest to the first main surface AA among the end surface internal electrodes 20 is defined as an outermost lateral surface internal electrode 50A, the outermost lateral surface internal electrode 50A has a larger cross-sectional area than the lateral surface internal electrode having the largest cross-sectional area among the lateral surface internal electrodes provided in either the second main surface side region or the intermediate region.

In this case, by mounting the multilayer ceramic capacitor 1 with the first main surface AA facing the mounting substrate, the outermost end surface internal electrode 20A and the outermost lateral surface internal electrode 50A having relatively large cross-sectional areas can be provided in the high-frequency region of the multilayer ceramic capacitor 1. In the high-frequency region, the influence of ESL occurs more significantly than in the low-frequency region. Therefore, by increasing the cross-sectional areas of the outermost end surface internal electrode 20A and the outermost lateral surface internal electrode 50A (that is, increasing the amount of metal), ESL can be effectively reduced.

### Coverage of Internal Electrode 15

The outermost end surface internal electrode 20A has a larger coverage than the end surface internal electrode 20 having the largest coverage (described in detail later) among the end surface internal electrodes 20 provided in either the second main surface-side region R2 or the intermediate region R3.

The outermost lateral surface internal electrode 50A has a larger coverage than the lateral surface internal electrode 50 having the largest coverage among the lateral surface internal electrodes 50 provided in either the second main surface-side region R2 or the intermediate region R3.

In this case, by mounting the multilayer ceramic capacitor 1 with the first main surface AA facing the mounting substrate, the outermost end surface internal electrode 20A and the outermost lateral surface internal electrode 50A having relatively large coverage can be provided in the high-frequency region of the multilayer ceramic capacitor 1. In the high-frequency region, the influence of ESL occurs more significantly than in the low-frequency region. Therefore, by increasing the coverage of the outermost end surface internal electrode 20A and the outermost lateral surface internal electrode 50A, ESL can be effectively reduced.

The coverage of the outermost end surface internal electrode 20A is, for example, preferably greater than about 90% and about 100% or less. The coverage of the outermost lateral surface internal electrode is, for example, preferably greater than about 90% and about 100% or less. In this case, by mounting the multilayer ceramic capacitor 1 with the first main surface AA facing the mounting substrate, ESL can be effectively reduced.

The coverage of each of the end surface internal electrodes 20 provided in either the second main surface side region R2 or the intermediate region R3 is, for example, about preferably 70% or more and about 90% or less. The coverage of each of the lateral surface internal electrodes 50 provided in either the second main surface side region R2 or the intermediate region R3 is, for example, preferably about 70% or more and about 90% or less. In this case, by mounting the multilayer ceramic capacitor 1 with the first main surface AA facing the mounting substrate, sufficient capacitance of the multilayer ceramic capacitor 1 can be ensured.

### Thickness of Internal Electrode 15

The outermost end surface internal electrode 20A has a greater thickness than the end surface internal electrode 20 having the largest thickness (described in detail later) among the end surface internal electrodes 20 provided in either the second main surface side region R2 or the intermediate region R3.

The outermost lateral surface internal electrode 50A has a greater thickness than the lateral surface internal electrode 50 having the largest thickness (described in detail later) among the lateral surface internal electrodes 50 provided in either the second main surface side region R2 or the intermediate region R3.

In this case, by mounting the multilayer ceramic capacitor 1 with the first main surface AA facing the mounting substrate, it is possible to provide the outermost end surface internal electrode 20A and the outermost lateral surface internal electrode 50A having relatively large thicknesses in the high-frequency region of the multilayer ceramic capacitor 1. In the high-frequency region, the influence of ESL occurs more significantly than in the low-frequency region. Therefore, by increasing the thickness of the outermost end surface internal electrode 20A and the outermost lateral surface internal electrode 50A, it is possible to reduce ESL effectively. Moreover, even with a small number of internal electrodes 15 having a large thickness, ESL can be effectively reduced, such that ESL can be reduced while reducing or preventing an increase in the dimension of the multilayer ceramic capacitor 1 in the lamination direction T.

Moreover, it is possible to provide the internal electrodes 15 having relatively small thickness in the low-frequency region of the multilayer ceramic capacitor 1. Therefore, the internal electrodes 15 can be multilayered in the low-frequency region where the influence of ESL is relatively less likely to occur. This makes it possible to achieve a large capacitance of the multilayer ceramic capacitor 1.

The thickness of the outermost end surface internal electrode 20A is, for example, preferably greater than about 150% of the thickness of the end surface internal electrode 20 having the largest thickness among the end surface internal electrodes 20 provided in either the second main surface side region R2 or the intermediate region R3. In this case, ESL can be reduced more effectively while achieving a large capacitance.

The thickness of the outermost lateral surface internal electrode 50A is, for example, preferably greater than about 150% of the thickness of the lateral surface internal electrode 50 having the largest thickness among the lateral surface internal electrodes 50 provided in either the second main surface side region R2 or the intermediate region R3. In this case, ESL can be reduced more effectively while achieving a large capacitance.

The thickness of the outermost end surface internal electrode 20A is, for example, preferably about 90% or more and about 110% or less of the thickness of the outermost lateral surface internal electrode 50A. In this case, ESL can be reduced more effectively.

The thickness of the outermost end surface internal electrode 20A is, for example, preferably about 0.65 μm or more. In this case, it is possible to more effectively reduce ESL.

Further, the maximum dimension in the lamination direction T of the multilayer body 2 is, for example, preferably 0.5 mm or less. In this case, it is possible to obtain the desired advantageous effects in a low-profile multilayer ceramic capacitor.

### Method for Measuring Cross-Sectional Area

The interior of each of the internal electrodes includes a metal portion and a cavity portion where no metal exists. When the internal electrodes and the dielectric layers are laminated, a ceramic material may be filled in some of the cavity portion. The cross-sectional area of the internal electrode is the area of the metal portion of the internal electrode in a predetermined cross section (described later).

When measuring the cross-sectional area of the internal electrode, the multilayer body is polished to expose a predetermined cross section. Next, the exposed cross section is observed with an optical microscope or the like to determine the area occupied by the metal portion within a predetermined range (described later).

### Method for Measuring Coverage

The coverage of the internal electrode is defined as the ratio occupied by the metal portion in the internal electrode. Specifically, when the entire internal electrode is defined as the sum of the metal portion (hereinafter referred to as (i)), the portion existing as a cavity without being filled with ceramic material (hereinafter referred to as (ii)), and the portion of the cavity filled with ceramic material (hereinafter referred to as (iii)), the coverage is defined as the ratio occupied by (i) in the entire internal electrode.

When measuring the coverage of the internal electrode, the multilayer body is polished to expose a predetermined cross section. Next, the exposed cross section is observed with an optical microscope or the like to determine the area of (i), the area of (ii), and the area of (iii) within a predetermined range. Next, the area of (i) is divided by the sum of the area of (i), the area of (ii), and the area of (iii) to determine the coverage.

### Method for Measuring Thickness

The thickness of the internal electrode is defined as the dimension in the lamination direction T of the internal electrode. When measuring the thickness of the internal electrode, the multilayer body is polished to expose a predetermined cross section. Then, the exposed cross section is observed with a micrometer or optical microscope to measure the thickness of the internal electrode. At this time, the thickness of the internal electrode can be determined by measuring the thickness of the internal electrode at a plurality of locations within a predetermined range and calculating the average value of each value.

In the case of the end surface internal electrode 20, the predetermined cross section is a cross section parallel or substantially parallel to the length direction L and the lamination direction T and passing through the middle portion in the width direction W of the end surface internal electrode 20, for example, the first reference cross section S1 shown in FIG. 2. In the case of the lateral surface internal electrode 50, the predetermined cross section is a cross section parallel or substantially parallel to the width direction W and the lamination direction T and passing through the middle portion in the length direction L of the lateral surface internal electrode 50, for example, the second reference cross section S2 shown in FIG. 3.

In the case of the end surface internal electrode 20, the predetermined range is one region located in the middle among three regions obtained by dividing the end surface internal electrode 20 into three equal or substantially equal portions in the length direction L in a cross section parallel or substantially parallel to the length direction L and the lamination direction T and passing through the middle portion in the width direction W of the end surface internal electrode 20, for example, the range shown as “X1” in FIG. 2. In the case of the lateral surface internal electrode 50, the predetermined range is one region located in the middle among three regions obtained by dividing the lateral surface internal electrode 50 into three equal or substantially equal portions in the width direction W in a cross section parallel or substantially parallel to the width direction W and the lamination direction T and passing through the middle portion in the length direction L of the lateral surface internal electrode 50, for example, the range shown as “X2” in FIG. 3.

Further, among the internal electrodes 15 provided in the first main surface-side region R1 of the multilayer body 2, the cross-sectional area, coverage, and thickness of the internal electrodes 15 excluding the outermost end surface internal electrode 20A and the outermost lateral surface internal electrode 50A are not particularly limited. Among the internal electrodes 15 provided in the first main surface side region R1, as the cross-sectional area, coverage, and thickness of the internal electrodes 15 excluding the outermost end surface internal electrode 20A and the outermost lateral surface internal electrode 50A of the multilayer body 2 are larger, ESL can be reduced more effectively. Further, among the internal electrodes 15 provided in the first main surface-side region R1 of the multilayer body 2, as the thickness of the internal electrodes 15 excluding the outermost end surface internal electrode 20A and the outermost lateral surface internal electrode 50A are smaller, it is possible to achieve increased capacitance easier through multilayering.

### Method of Manufacturing Multilayer Ceramic Capacitor 1

Next, an example of a method of manufacturing the multilayer ceramic capacitor 1 of the present example embodiment will be described.

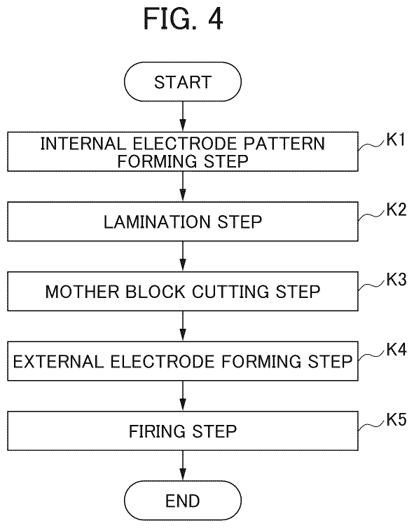

FIG. 4 is a flowchart explaining the example of the method of manufacturing the multilayer ceramic capacitor 1.

### Internal Electrode Pattern Forming Step K1

As shown in FIG. 4, an electrically conductive paste is printed (applied) on a ceramic green sheet that defines and functions as the first dielectric layer 141 to form the end surface internal electrode 20. Similarly, an electrically conductive paste is applied on a ceramic green sheet that defines and functions as the second dielectric layer 142 to form the lateral surface internal electrode 50. By adjusting the application amount of the electrically conductive paste, it is possible to adjust the cross-sectional area, coverage, and thickness of the internal electrode 15.

The ceramic green sheet is a strip-shaped sheet formed by molding a ceramic slurry including ceramic powder, binder, and solvent into a sheet shape on a carrier film using, for example, a die coater, gravure coater, microgravure coater, or the like. The end surface internal electrode 20 and the lateral surface internal electrode 50 are formed by printing such as, for example, screen printing, gravure printing, relief printing, or the like.

### Lamination Step K2

The ceramic green sheets that define and function as the first dielectric layers 141 on which the end surface internal electrodes 20 are provided and the ceramic green sheets that define and function as the second dielectric layers 142 on which the lateral surface internal electrodes 50 are provided are alternately laminated. Subsequently, ceramic green sheets for the outer layer portions are provided on the upper and lower sides and thermocompression bonded to form a mother block.

### Mother Block Cutting Step K3

Next, the mother block is cut and divided in the length direction L and the width direction W to manufacture a plurality of rectangular or substantially rectangular parallelepiped multilayer bodies 2.

### External Electrode Forming Step K4

Next, the end surface external electrodes 3 are formed on both end surfaces C of the multilayer body 2, and the lateral surface external electrodes 4 are formed on both lateral surfaces B of the multilayer body 2. The first extension portions 22 of the end surface internal electrodes 20 are connected to each end surface external electrode 3. Each end surface external electrode 3 is formed to cover not only the end surface C, but also a portion of the main surface A and a portion of the lateral surface B adjacent to the end surface C. The second extension portions 52 of the lateral surface internal electrodes 50 are connected to the lateral surface external electrodes 4. Each lateral surface external electrode 4 is formed to cover not only the lateral surface B, but also a portion of the main surface A adjacent to the lateral surface B.

### Firing Step K5

The multilayer body 2 on which the end surface external electrodes 3 and the lateral surface external electrodes 4 are provided is heated at a set firing temperature for a predetermined time in a nitrogen atmosphere, for example. Thus, the end surface external electrodes 3 and the lateral surface external electrodes 4 are fired on the multilayer body 2, and the multilayer ceramic capacitor 1 shown in FIG. 1 is obtained.

### Advantageous Effects According to First Example Embodiment

According to the present example embodiment, it is possible to achieve the following advantageous effects.

According to the present example embodiment, the outermost end surface internal electrode 20A has a larger cross-sectional area in the first reference cross-section S1 than the end surface internal electrode 20 having the largest cross-sectional area in the first reference cross-section S1 among the end surface internal electrodes 20 provided in either the second main surface-side region R2 or the intermediate region R3, and the outermost lateral surface internal electrode 50A has a larger cross-sectional area in the second reference cross-section S2 than the lateral surface internal electrode 50 having the largest cross-sectional area in the second reference cross-section S2 among the lateral surface internal electrodes 50 provided in either the second main surface-side region R2 or the intermediate region R3.

In this case, by mounting the multilayer ceramic capacitor 1 with the first main surface AA facing the mounting substrate, it is possible to provide the outermost end surface internal electrode 20A and the outermost lateral surface internal electrode 50A having relatively large cross-sectional areas in the high-frequency region of the multilayer ceramic capacitor 1. In the high-frequency region, the influence of ESL occurs more significantly than in the low-frequency region. Therefore, by increasing the cross-sectional areas of the outermost end surface internal electrode 20A and the outermost lateral surface internal electrode 50A (that is, increasing the amount of metal), it is possible to effectively reduce ESL.

According to the present example embodiment, the coverage of the outermost end surface internal electrode 20A is, for example, preferably greater than about 90% and about 100% or less, and the coverage of the outermost lateral surface internal electrode 50A is, for example, preferably greater than about 90% and about 100% or less.

In this case, by mounting the multilayer ceramic capacitor 1 with the first main surface AA facing the mounting substrate, it is possible to reduce ESL effectively.

According to the present example embodiment, the coverage of the end surface internal electrodes 20 provided in either the second main surface-side region R2 or the intermediate region R3 is, for example, preferably about 70% or more and about 90% or less, and the coverage of the lateral surface internal electrodes 50 provided in either the second main surface-side region R2 or the intermediate region R3 is, for example, preferably about 70% or more and about 90% or less.

In this case, by mounting the multilayer ceramic capacitor 1 with the first main surface AA facing the mounting substrate, it is possible to effectively ensure the capacitance of the multilayer ceramic capacitor 1.

According to the present example embodiment, the thickness of the outermost end surface internal electrode 20A in the first reference cross section S1 is, for example, preferably about 90% or more and about 110% or less with respect to the thickness of the outermost lateral surface internal electrode 50A in the second reference cross section S2.

In this case, it is possible to reduce ESL more effectively.

According to the present example embodiment, the outermost end surface internal electrode 20A preferably has a greater thickness than the end surface internal electrode 20 having the largest thickness (described in detail later) among the end surface internal electrodes 20 provided in either the second main surface-side region R2 or the intermediate region R3, and the outermost lateral surface internal electrode 50A preferably has a greater thickness than the lateral surface internal electrode 50 having the largest thickness (described in detail later) among the lateral surface internal electrodes 50 provided in either the second main surface-side region R2 or the intermediate region R3.

In this case, by mounting the multilayer ceramic capacitor 1 with the first main surface AA facing the mounting substrate, it is possible to provide the outermost end surface internal electrode 20A and the outermost lateral surface internal electrode 50A having relatively large thicknesses in the high frequency region of the multilayer ceramic capacitor 1. In the high frequency region, the influence of ESL occurs more significantly than in the low frequency region. Therefore, by increasing the thickness of the outermost end surface internal electrode 20A and the outermost lateral surface internal electrode 50A, it is possible to reduce ESL effectively. In addition, even with a small number of internal electrodes 15 having large thickness, ESL can be effectively reduced, such that ESL can be reduced while reducing or preventing an increase in the dimension of the multilayer ceramic capacitor 1 in the lamination direction T.

In addition, it is possible to provide the internal electrodes 15 having relatively small thicknesses in the low frequency region of the multilayer ceramic capacitor 1. Therefore, the internal electrodes 15 can be multilayered in the low frequency region where the influence of ESL is relatively less likely to occur. This makes it possible to achieve a large capacitance of the multilayer ceramic capacitor 1.

According to the present example embodiment, in the first reference cross section S1, the thickness of the outermost end surface internal electrode 20A is, for example, preferably greater than about 150% with respect to the thickness of the end surface internal electrode 20 having the largest thickness among the end surface internal electrodes 20 provided in either the second main surface-side region R2 or the intermediate region R3.

In this case, it is possible to preferably achieve a large capacitance while reducing ESL.

According to the present example embodiment, in the second reference cross-section S2, the thickness of the outermost lateral surface internal electrode 50A is, for example, preferably greater than about 150% of the thickness of the lateral surface internal electrode 50 having the largest thickness among the lateral surface internal electrodes 50 provided in either the second main surface-side region R2 or the intermediate region R3.

In this case, it is possible to preferably achieve a large capacitance while reducing ESL.

According to the present example embodiment, the thickness of the outermost end surface internal electrode 20A in the first reference cross-section S1 is, for example, preferably about 0.65 μm or more.

In this case, it is possible to more preferably reduce ESL.

According to the present example embodiment, the maximum dimension of the multilayer body 2 in the lamination direction T is, for example, preferably about 0.5 mm or less. In this case, it is possible to obtain the advantageous effects in a low-profile multilayer ceramic capacitor.

### Second Example Embodiment

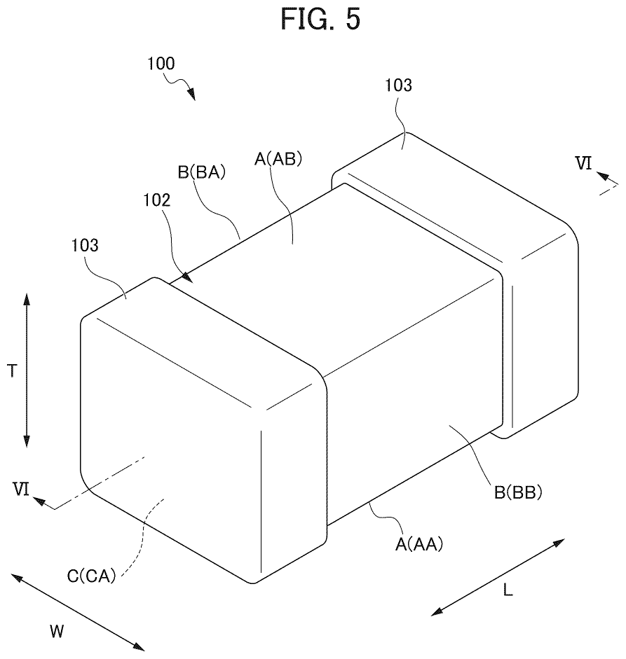

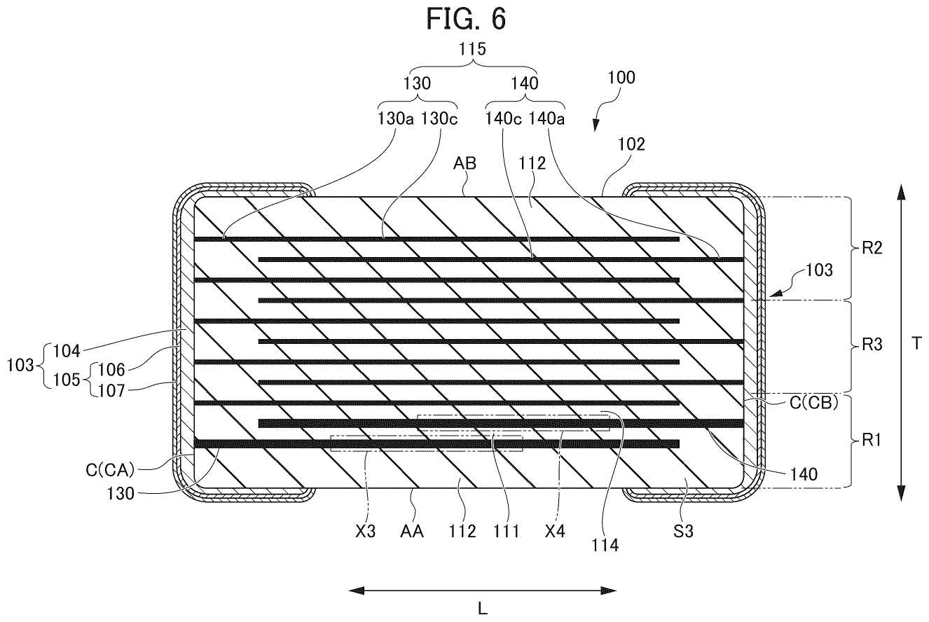

Next, a multilayer ceramic capacitor 100 according to a second example embodiment of the present invention will be described with reference to FIGS. 5 and 6. The multilayer ceramic capacitor 100 is a multilayer ceramic capacitor having a two-terminal configuration. The description will focus on differences from the multilayer ceramic capacitor 1 according to the first example embodiment, and the same reference numerals may be assigned to the same configurations as those of the multilayer ceramic capacitor 1 according to the first example embodiment, and descriptions thereof may be omitted.

FIG. 5 is a schematic perspective view of the multilayer ceramic capacitor 100 according to the second example embodiment. FIG. 6 is a cross-sectional view of the multilayer ceramic capacitor 100 taken along the VI-VI direction in FIG. 5. The cross-section of FIG. 6 is a cross-section parallel or substantially parallel to the length direction L and the lamination direction T and passing through the middle portion of the multilayer body 102 in the width direction W, and may be referred to as “reference cross-section S3”.

As shown in FIG. 5, the multilayer ceramic capacitor 100 has a rectangular or substantially rectangular parallelepiped shape and includes a multilayer body 102 and a pair of external electrodes 103.

The multilayer body 102 has a rectangular or substantially rectangular parallelepiped shape and includes an inner layer portion 111 and outer layer portions 112 provided on both sides of the inner layer portion 111 in the lamination direction T.

As shown in FIG. 6, the inner layer portion 11 includes a plurality of dielectric layers 114 and internal electrodes 115 laminated along the lamination direction T.

The internal electrodes 115 include first end surface-side internal electrodes 130 that extend toward a first end surface CA and second end surface side internal electrodes 140 that extend toward a second end surface CB. The first end surface-side internal electrodes 130 and the second end surface-side internal electrodes 140 are alternately provided in the lamination direction T.

Each of the first end surface-side internal electrodes 130 includes a third counter portion 130c located in the middle portion between both end surfaces C, and a third extension portion 130a extending from the third counter portion 130c toward the first end surface CA. The third extension portion 130c is exposed at the first end surface CA of the multilayer body 102. The first end surface-side internal electrodes 130 are spaced apart from the second end surface CB and both lateral surfaces B.

Each of the second end surface-side internal electrodes 140 includes a fourth counter portion 140c located in the middle portion between both end surfaces C, and a fourth extension portion 140a extending from the fourth counter portion 140c toward the second end surface CB. The fourth extension portion 140a is exposed at the second end surface CB of the multilayer body 102. The second end surface-side internal electrodes 140 are spaced apart from the first end surface CA and both lateral surfaces B.

The pair of external electrodes 103 are provided on the end surfaces C, respectively. Each of the external electrodes 103 covers not only the end surface C, but also a portion of the main surface A and a portion of the lateral surface B adjacent to the end surface C. Each of the external electrodes 103 includes, for example, a base electrode layer 104, a Ni plated layer 105 provided on the base electrode layer 104, and a Sn plated layer 106 provided on the Ni plated layer 105. The first end surface-side internal electrodes 130 (the third extension portions 130a) are connected to the external electrode 103 adjacent to the first end surface CA. The second end surface-side internal electrodes 140 (the fourth extension portions 140a) are connected to the external electrode 103 adjacent to the second end surface CB.

Here, when a first end surface-side internal electrode 130 closest to the first main surface AA among the first end surface-side internal electrodes 130 is defined as an outermost first end surface-side internal electrode 130A, the outermost first end surface-side internal electrode 130A has a larger cross-sectional area than the first end surface-side internal electrode 130 having the largest cross-sectional area among the first end surface side internal electrodes 130 provided in either the second main surface-side region R2 or the intermediate region R3.

When an second end surface-side internal electrode 140 closest to the first main surface AA among the second end surface-side internal electrodes 140 is defined as an outermost second end surface-side internal electrode 140A, the outermost second end surface-side internal electrode 140A has a larger cross-sectional area than the second end surface-side internal electrode 140 having the largest cross-sectional area among the second end surface-side internal electrodes 140 provided in either the second main surface-side region R2 or the intermediate region R3 of the multilayer body 102.

In this case, by mounting the multilayer ceramic capacitor 100 with the first main surface AA facing the mounting substrate, it is possible to provide the outermost first end surface-side internal electrode 130A and the outermost second end surface-side internal electrode 140A having relatively large cross-sectional areas in the high-frequency region of the multilayer ceramic capacitor 1. This makes it possible to effectively reduce ESL in the multilayer ceramic capacitor 100, which is a two-terminal type multilayer ceramic capacitor.

The outermost first end surface-side internal electrode 130A has a larger coverage than the first end surface-side internal electrode 130 having the largest coverage among the first end surface-side internal electrodes 130 provided in either the second main surface-side region R2 or the intermediate region R3 of the multilayer body 102.

The outermost second end surface-side internal electrode 140A has a larger coverage than the second end surface-side internal electrode 140 having the largest coverage among the second end surface-side internal electrodes 140 provided in either the second main surface-side region R2 or the intermediate region R3.

In this case, by mounting the multilayer ceramic capacitor 100 with the first main surface AA facing the mounting substrate, it is possible to provide the outermost first end surface-side internal electrode 130A and the outermost second end internal electrode 140A having relatively large surface-side coverage in the high-frequency region of the multilayer ceramic capacitor 100. This makes it possible to effectively reduce ESL.

The coverage of the outermost first end surface-side internal electrode 130A is, for example, greater than about 90% and about 100% or less. It is preferable that the coverage of the outermost second end surface-side internal electrode is, for example, greater than about 90% and about 100% or less. In this case, by mounting the multilayer ceramic capacitor 100 with the first main surface AA facing the mounting substrate, it is possible to effectively reduce ESL.

It is preferable that the coverage of the first end surface-side internal electrode 130 provided in either the second main surface-side region R2 or the intermediate region R3 of the multilayer body 102 is, for example, about 70% or more and about 90% or less. It is preferable that the coverage of the second end surface-side internal electrode 140 provided in either the second main surface side region R2 or the intermediate region R3 of the multilayer body 102 is, for example, about 70% or more and about 90% or less. In this case, by mounting the multilayer ceramic capacitor 100 with the first main surface AA facing the mounting substrate, it is possible to sufficiently ensure the capacitance of the multilayer ceramic capacitor 100.

The outermost first end surface-side internal electrode 130A has a greater thickness than the first end surface-side internal electrode 130 having the largest thickness among the first end surface-side internal electrodes 130 provided in either the second main surface side region R2 or the intermediate region R3 of the multilayer body 102.

The outermost second end surface-side internal electrode 140A has a greater thickness than the second end surface-side internal electrode 140 having the largest thickness among the second end surface-side internal electrodes 140 provided in either the second main surface-side region R2 or the intermediate region R3 of the multilayer body 102.

In this case, by mounting the multilayer ceramic capacitor 100 with the first main surface AA facing the mounting substrate, it is possible to provide the outermost first end surface-side internal electrode 130A and the outermost second end surface-side internal electrode 140A having relatively large thicknesses in the high-frequency region of the multilayer ceramic capacitor 100. This makes it possible to effectively reduce ESL. In addition, even with a small number of internal electrodes 115 having large thickness, it is possible to effectively reduce ESL, and therefore it is possible to reduce ESL while reducing or preventing an increase in the dimension of the multilayer ceramic capacitor 100 in the lamination direction T.

In addition, since the internal electrodes 115 having a relatively small thickness are provided in the low-frequency region of the multilayer ceramic capacitor 100, it is possible to provide multiple layers of the internal electrodes 115 in the low-frequency region and achieve a large capacitance of the multilayer ceramic capacitor 1.

It is preferable that the thickness of the outermost first end surface-side internal electrode 130A is, for example, greater than about 150% of the thickness of the first end surface side internal electrode 130 having the largest thickness among the first end surface-side internal electrodes 130 provided in either the second main surface-side region R2 or the intermediate region R3 of the multilayer body 102. It is preferable that the thickness of the outermost second end surface-side internal electrode 140A is, for example, greater than about 150% of the thickness of the second end surface-side internal electrode 140 having the largest thickness among the second end surface-side internal electrodes 140 provided in either the second main surface-side region R2 or the intermediate region R3 of the multilayer body 102. In this case, it is possible to more effectively reduce ESL while achieving a large capacitance.

It is preferable that the thickness of the outermost first end surface-side internal electrode 130A is, for example, about 90% or more and about 110% or less of the thickness of the outermost second end surface-side internal electrode 140A. In this case, it is possible to more effectively reduce ESL.

In addition, it is preferable that the maximum dimension of the multilayer body 102 in the lamination direction T is, for example, about 0.5 mm or less. In this case, it is possible to obtain the advantageous effects in a low-profile multilayer ceramic capacitor.

In addition, in measuring the cross-sectional area, coverage, and thickness of the internal electrodes 115, the predetermined cross section is a cross section that is parallel or substantially parallel to the width direction W and the lamination direction T and passes through the middle portion in the length direction L of the lateral surface internal electrode 50, and is, for example, the reference cross section S3 shown in FIG. 6.

In the case of the first end surface-side internal electrode 130, the predetermined range is one region located in the middle among three regions obtained by dividing the first end surface-side internal electrode 130 into three equal or substantially equal portions in the length direction L in a cross section that is parallel or substantially parallel to the length direction L and the lamination direction T and passes through the middle portion in the width direction W of the first end surface-side internal electrode 130, and is, for example, the range shown as “X3” in FIG. 6. In the case of the second end surface side internal electrode 140, the predetermined range is one region located in the middle among three regions obtained by dividing the second end surface-side internal electrode 140 into three equal or substantially equal portions in the width direction W in a cross section that is parallel or substantially parallel to the width direction W and the lamination direction T and passes through the middle portion in the length direction L of the second end surface-side internal electrode 140, and is, for example, the range shown as “X4” in FIG. 6.

Further, the cross-sectional area, coverage, and thickness of each of the internal electrodes 115 provided in the first main surface-side region R1 of the multilayer body 102, excluding the outermost first end surface-side internal electrode 130A and the outermost second end surface-side internal electrode 140A, are not particularly limited. Among the internal electrodes 115 provided in the first main surface-side region R1 of the multilayer body 102, as the cross-sectional area, coverage, and thickness of each of the internal electrodes 115 excluding the outermost first end surface-side internal electrode 130A and the outermost second end surface-side internal electrode 140A are larger, ESL can be reduced more effectively. Further, among the internal electrodes 115 provided in the first main surface-side region R1 of the multilayer body 102, as the thickness of each of the internal electrodes 115 excluding the outermost first end surface-side internal electrode 130A and the outermost second end surface-side internal electrode 140A is smaller, it is possible to achieve an increase in capacitance by multilayering easier.

### Manufacturing Method of Multilayer Ceramic Capacitor 100

Next, an example of a manufacturing method of the multilayer ceramic capacitor 100 according to the second example embodiment will be described.

First, ceramic green sheets are prepared in which patterns of the internal electrodes 115 are printed with an electrically conductive paste on ceramic green sheets for lamination formed by shaping ceramic slurry into sheet form. The application amount of the electrically conductive paste is adjusted to achieve the desired cross-sectional area, coverage, thickness, and the like of each of the internal electrodes 115.

Next, a plurality of ceramic green sheets are stacked such that the internal electrode patterns are shifted by about half a pitch in the length direction between adjacent ceramic green sheets. Next, ceramic green sheets for manufacturing outer layer portions are provided on the upper and lower sides and thermocompression bonded to form a mother block. Next, the mother block is cut and divided in the length direction L and the width direction W to manufacture a plurality of rectangular or substantially rectangular parallelepiped multilayer bodies 102.

Next, external electrodes 103 are formed on both end surfaces C of the multilayer body 102. The multilayer body 102 with the external electrodes 103 provided thereon is heated at a set firing temperature in a nitrogen atmosphere, for example, for a predetermined time. Thus, the external electrodes 103 are fired on the multilayer body 102, and the multilayer ceramic capacitor 100 shown in FIG. 1 is obtained.

### Advantageous Effects of Second Example Embodiment

According to the present example embodiment, it is possible to achieve the following advantageous effects.

According to the present example embodiment, the outermost first end surface-side internal electrode 130A has a larger cross-sectional area in the reference cross section S3 than the first end surface-side internal electrode 130 having the largest cross-sectional area in the reference cross section S3 among the first end surface-side internal electrodes 130 provided in either the second main surface-side region R2 or the intermediate region R3, and the outermost second end surface-side internal electrode 140A has a larger cross-sectional area in the reference cross section S3 than the second end surface-side internal electrode 140 having the largest cross-sectional area in the reference cross section S3 among the second end surface-side internal electrodes 140 provided in either the second main surface-side region R2 or the intermediate region R3.

In this case, by mounting the multilayer ceramic capacitor 100 with the first main surface AA facing the mounting substrate, it is possible to provide the outermost first end surface-side internal electrode 130A and the outermost second end surface-side internal electrode 140A having relatively large cross-sectional areas in the high-frequency region of the multilayer ceramic capacitor 1. Thus, in the multilayer ceramic capacitor 100, which is a two-terminal type multilayer ceramic capacitor, it is possible to reduce ESL effectively.

According to the present example embodiment, the coverage of the outermost first end surface-side internal electrode 130A is, for example, preferably greater than about 90% and about 100% or less, and the coverage of the outermost second end surface-side internal electrode 140A is, for example, preferably greater than about 90% and about 100% or less.

In this case, by mounting the multilayer ceramic capacitor 100 with the first main surface AA facing the mounting substrate, it is possible to reduce ESL effectively.

According to the present example embodiment, the coverage of each of the first end surface-side internal electrodes 130 provided in either the second main surface-side region R2 or the intermediate region R3 is, for example, preferably about 70% or more and about 90% or less, and the coverage of each of the second end surface-side internal electrodes 140 provided in either the second main surface-side region R2 or the intermediate region R3 is, for example, preferably about 70% or more and about 90% or less.

In this case, by mounting the multilayer ceramic capacitor 100 with the first main surface AA facing the mounting substrate, it is possible to effectively ensure the capacitance of the multilayer ceramic capacitor 100.

According to the present example embodiment, in the reference cross section S3, the thickness of the outermost first end surface-side internal electrode 130A is, for example, preferably about 90% or more and about 110% or less with respect to the thickness of the outermost second end surface-side internal electrode 140A.

In this case, it is possible to reduce ESL more effectively.

According to the present example embodiment, the outermost first end surface-side internal electrode 130A preferably has a greater thickness than the first end surface-side internal electrode 130 having the largest thickness among the first end surface-side internal electrodes 130 provided in either the second main surface-side region R2 or the intermediate region R3 of the multilayer body 102, and the outermost second end surface-side internal electrode 140A preferably has a larger thickness than the second end surface-side internal electrode 140 having the largest thickness among the second end surface-side internal electrodes 140 provided in either the second main surface-side region R2 or the intermediate region R3 of the multilayer body 102.

In this case, by mounting the multilayer ceramic capacitor 100 with the first main surface AA facing the mounting substrate, it is possible to provide the outermost first end surface-side internal electrode 130A and the outermost second end surface-side internal electrode 140A, which have relatively large thicknesses, in the high frequency region of the multilayer ceramic capacitor 100. Thus, it is possible to reduce ESL effectively. Also, even with a small number of internal electrodes 15 having a large thickness, ESL can be effectively reduced, such that it is possible to reduce ESL while reducing or preventing an increase in the dimension in the lamination direction T of the multilayer ceramic capacitor 100.

Also, since the internal electrodes 115 having relatively small thicknesses are provided in the low frequency region of the multilayer ceramic capacitor 100, the internal electrodes 115 can be multilayered in the low frequency region, such that it is possible to achieve the increased capacitance of the multilayer ceramic capacitor 1.

According to the present example embodiment, in the reference cross section S3, the thickness of the outermost first end surface-side internal electrode 130A is, for example, preferably greater than about 150% with respect to the thickness of the first end surface-side internal electrode 130 having the largest thickness among the first end surface-side internal electrodes 130 provided in either the second main surface-side region R2 or the intermediate region R3, and the thickness of the outermost second end surface-side internal electrode 140A is, for example, preferably greater than about 150% with respect to the thickness of the second end surface-side internal electrode 140 having the largest thickness among the second end surface-side internal electrodes 140 provided in either the second main surface-side region R2 or the intermediate region R3.

In this case, it is possible to reduce ESL while achieving a larger capacitance more effectively.

According to the present example embodiment, it is preferable that the maximum dimension of the multilayer body 102 in the lamination direction T is, for example, about 0.5 mm or less.

In this case, it is possible to obtain the advantageous effects in a low-profile multilayer ceramic capacitor.

While example embodiments of the present invention have been described above, the present invention is not limited to the above-described example embodiments, and various changes and modifications can be made.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrodes each on a corresponding one of the plurality of dielectric layers, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction;
a pair of end surface external electrodes on the first end surface and the second end surface, respectively; and
a pair of lateral surface external electrodes on the first lateral surface and the second lateral surface, respectively; wherein
the plurality of internal electrodes include end surface internal electrodes exposed at each of the first end surface and the second end surface, and lateral surface internal electrodes exposed at each of the first lateral surface and the second lateral surface; and
when a cross section parallel or substantially parallel to the length direction and the lamination direction and passing through a middle portion of the end surface internal electrodes in the width direction is defined as a first reference cross section, a cross section parallel or substantially parallel to the width direction and the lamination direction and passing through a middle portion of the lateral surface internal electrodes in the length direction is defined as a second reference cross section, and the multilayer body is equally or substantially equally divided into three regions in the lamination direction to define a first main surface-side region located adjacent to the first main surface, a second main surface-side region located adjacent to the second main surface, and an intermediate region located between the first main surface-side region and the second main surface-side region:
an end surface internal electrode closest to the first main surface among the end surface internal electrodes has a larger cross-sectional area in the first reference cross section than a cross-sectional area in the first reference cross section of an end surface internal electrode having a largest cross-sectional area among the end surface internal electrodes provided in either the second main surface-side region or the intermediate region; and
a lateral surface internal electrode closest to the first main surface among the lateral surface internal electrodes has a larger cross-sectional area in the second reference cross section than a cross-sectional area in the second reference cross section of a lateral surface internal electrode having a largest cross-sectional area among the lateral surface internal electrodes provided in either the second main surface-side region or the intermediate region.

2. The multilayer ceramic capacitor according to claim 1, wherein
a coverage of the end surface internal electrode closest to the first main surface among the end surface internal electrodes is greater than about 90% and about 100% or less; and
a coverage of the lateral surface internal electrode closest to the first main surface among the lateral surface internal electrodes is greater than about 90% and about 100% or less.

3. The multilayer ceramic capacitor according to claim 1, wherein
a coverage of each of the end surface internal electrodes provided in either the second main surface-side region or the intermediate region is about 70% or more and about 90% or less; and
a coverage of each of the lateral surface internal electrodes provided in either the second main surface-side region or the intermediate region is about 70% or more and about 90% or less.

4. The multilayer ceramic capacitor according to claim 1, wherein a thickness of the end surface internal electrode closest to the first main surface among the end surface internal electrodes in the first reference cross section is about 90% or more and about 110% or less of a thickness of the lateral surface internal electrode closest to the first main surface among the lateral surface internal electrodes in the second reference cross section.

5. The multilayer ceramic capacitor according to claim 1, wherein, in the first reference cross section, a thickness of the end surface internal electrode closest to the first main surface among the end surface internal electrodes is greater than about 150% of a thickness of an end surface internal electrode having a largest thickness among the end surface internal electrodes provided in either the second main surface-side region or the intermediate region.

6. The multilayer ceramic capacitor according to claim 1, wherein, in the second reference cross section, a thickness of the lateral surface internal electrode closest to the first main surface among the lateral surface internal electrodes is greater than about 150% of a thickness of a lateral surface internal electrode having a largest thickness among the lateral surface internal electrodes provided in either the second main surface-side region or the intermediate region.

7. The multilayer ceramic capacitor according to claim 1, wherein a thickness of the end surface internal electrode closest to the first main surface among the end surface internal electrodes in the first reference cross section is about 0.65 μm or more.

8. The multilayer ceramic capacitor according to claim 1, wherein a maximum dimension of the multilayer body in the lamination direction is about 0.5 mm or less.

9. The multilayer ceramic capacitor according to claim 1, wherein each of the plurality of internal electrode layers includes Ni, Cu, Ag, Pd, Ag—Pd alloy, or Au.

10. The multilayer ceramic capacitor according to claim 1, wherein each of the plurality of dielectric layers includes BaTiO₃.

11. The multilayer ceramic capacitor according to claim 1, wherein each of the end surface external electrodes and each of the lateral surface external electrodes includes a base electrode layer and a plated layer on the base electrode layer.

12. A multilayer ceramic capacitor comprising:
a multilayer body including a plurality of dielectric layers and a plurality of internal electrodes each on a corresponding one of the plurality of dielectric layers, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction; and
a pair of external electrodes on the first end surface and the second end surface, respectively; wherein
the plurality of internal electrodes include first end surface-side internal electrodes exposed only at the first end surface and second end surface-side internal electrodes exposed only at the second end surface;
when a cross section parallel or substantially parallel to the length direction and the lamination direction and passing through a middle portion of the multilayer body in the width direction is defined as a reference cross section, and the multilayer body is equally or substantially equally divided into three regions in the lamination direction to define a first main surface-side region located adjacent to the first main surface, a second main surface-side region located adjacent to the second main surface, and an intermediate region located between the first main surface-side region and the second main surface-side region:
a first end surface-side internal electrode closest to the first main surface among the first end surface-side internal electrodes has a larger cross-sectional area in the reference cross section than a cross-sectional area in the reference cross section of a first end surface-side internal electrode having the largest cross-sectional area among the first end surface-side internal electrodes provided in either the second main surface-side region or the intermediate region; and
a second end surface-side internal electrode closest to the first main surface among the second end surface-side internal electrodes has a larger cross-sectional area in the reference cross section than a cross-sectional area in the reference cross section of a second end surface-side internal electrode having the largest cross-sectional area among the second end surface-side internal electrodes provided in either the second main surface-side region or the intermediate region.

13. The multilayer ceramic capacitor according to claim 12, wherein
a coverage of the first end surface-side internal electrode closest to the first main surface among the first end surface-side internal electrodes is greater than about 90% and about 100% or less; and
a coverage of the second end surface-side internal electrode closest to the first main surface among the second end surface-side internal electrodes is greater than about 90% and about 100% or less.

14. The multilayer ceramic capacitor according to claim 12, wherein
a coverage of each of the first end surface-side internal electrodes provided in either the second main surface-side region or the intermediate region is about 70% or more and about 90% or less; and
a coverage of each of the second end surface-side internal electrodes provided in either the second main surface-side region or the intermediate region is about 70% or more and about 90% or less.

15. The multilayer ceramic capacitor according to claim 12, wherein, in the reference cross section, a thickness of the first end surface-side internal electrode closest to the first main surface among the first end surface-side internal electrodes is about 90% or more and about 110% or less of a thickness of a second end surface-side internal electrode closest to the first main surface among the second end surface-side internal electrodes.

16. The multilayer ceramic capacitor according to claim 12, wherein, in the reference cross section, a thickness of the first end surface-side internal electrode closest to the first main surface among the first end surface-side internal electrodes is greater than about 150% of a thickness of a first end surface-side internal electrode having a largest thickness among the first end surface-side internal electrodes provided in either the second main surface-side region or the intermediate region, and a thickness of the second end surface-side internal electrode closest to the first main surface among the second end surface-side internal electrodes is greater than about 150% of a thickness of a second end surface-side internal electrode having a largest thickness among the second end surface-side internal electrodes provided in either the second main surface-side region or the intermediate region.

17. The multilayer ceramic capacitor according to claim 12, wherein a maximum dimension of the multilayer body in the lamination direction is about 0.5 mm or less.

18. The multilayer ceramic capacitor according to claim 12, wherein each of the plurality of internal electrode layers includes Ni, Cu, Ag, Pd, Ag—Pd alloy, or Au.

19. The multilayer ceramic capacitor according to claim 12, wherein each of the plurality of dielectric layers includes BaTiO₃.

20. The multilayer ceramic capacitor according to claim 12, wherein each of the external electrodes includes a base electrode layer and a plated layer on the base electrode layer.
